(19) United States
(12) Patent Application Publication
(10) Pub. No.: US 2025/0286058 A1
(43) Pub. Date: Sep. 11, 2025

(54) CATHODE MATERIALS FOR ALKALI METAL-ION BATTERIES AND METHODS OF MAKING THE SAME

(71) Applicant: Georgia Tech Research Corporation, Atlanta, GA (US)

(72) Inventors: Hailong Chen, Atlanta, GA (US); Zhantao Liu, Atlanta, GA (US)

(21) Appl. No.: 18/859,123

(22) PCT Filed: Apr. 28, 2023
(86) PCT No.: PCT/US2023/066360

§ 371 Date: Oct. 22, 2024

Related U.S. Application Data
(60) Provisional application No. 63/363,875, filed on Apr. 29, 2022.

(51) Int. Cl. H01M 4/58; C01F 17/36; C01G 25/00; H01M 10/0525; H01M 10/054; H01M 10/0562

(52) U.S. Cl. CPC H01M 4/582; C01F 17/36; C01G 25/006; H01M 10/0525; H01M 10/054; H01M 10/0562; C01P 2002/72; C01P 2002/77; C01P 2006/40; H01M 2300/008

(57) ABSTRACT

An exemplary embodiment of the present disclosure provides a cathode for use in an alkali metal-ion battery, the cathode comprising a metal halide crystal lattice. The metal halide has a formula: (Fel-zMa)(ClyX3-y), where Mi is a metal, X is a halogen, a is between 0 and 2.9, z is between 1 and 0, and y is between 0 and 3. Metal M can be a metal selected from the group consisting of titanium, chromium, manganese, cobalt, nickel, copper, zinc, molybdenum, technetium, ruthenium, vanadium, tungsten, rhenium, osmium, lithium, sodium, potassium, rubidium, or cesium, and halogen X can be selected from fluorine, bromine, or iodine.

### CROSS-REFERENCE TO RELATED APPLICATIONS

This application claims the benefit of U.S. Provisional Application Ser. No. 63/363,875, filed on 29 Apr. 2022, which is incorporated herein by reference in its entirety as if fully set forth below.

### FEDERALLY SPONSORED RESEARCH STATEMENT

This invention was made with government support under grant/award number 2004878 awarded by the National Science Foundation. The government has certain rights in the invention.

### FIELD OF THE DISCLOSURE

The various embodiments of the present disclosure relate generally to alkali metal-ion batteries, and more particularly to cathode materials comprising iron chloride.

### BACKGROUND

High-capacity and high performance electroactive materials are a prerequisite for adoption of technologies with new battery materials, such as smart Internet of Things (IoT) devices and electric vehicles (EVs). Solid-state lithium-ion batteries (LIBs) are considered a promising battery technology for the next generation of electrochemical energy storage. Current electrochemical cells are made with traditional cathode materials, such as LiCoO₂, LiMn₂O₄, LiFePO₄ and nickel, manganese, and cobalt (NMC) materials. These cells also utilize a liquid electrolyte to flow ions through the cell to create a voltage. Common commercial LIBs contain flammable fluid organic electrolytes to accomplish this, which may cause fire or explosion in harsh or abusive environments. The volume required for battery packs using a liquid electrolyte is quite large, making these LIBs bulky, dense, and cumbersome to use. These problems have made LIBs difficult to scale-up and potentially dangerous to the consumer under harsh conditions.

The increasing needs from electrified transportation and grid power storage are demanding electrochemical energy storage devices with higher energy density and, particularly, much lower cost than current LIBs. Because most LIBs are layered oxides, which are made from expensive semi-precious raw materials, such as Co, and require high temperature calcination. Fe is a very attractive redox active element due to the low cost and low toxicity, but unfortunately LiFeO₂ does not cycle in LIBs. LiFePO₄ is less expensive than layered oxides in raw materials, but it commonly requires carbon coating and nanosizing, which makes the manufacturing cost high.

Besides layered oxides, most binary compounds are working as conversion cathode/anode in LIBs, such as fluorides, though a small portion of intercalation capacity was observed in fluorides such as FeF₂, CuF₂ and FeF₃. The reported Li intercalation plateau of FeF₃ varies from 3.0˜3.3 V, usually associated with large voltage hysteresis and low-energy efficiency, which limits its practical applications. Chlorides in principle should be a better host for Li intercalation than fluoride as the greater size of Cl⁻ than F⁻ may allow better diffusion channels in the lattice. However, most metal chlorides are soluble in commonly used organic liquid electrolytes (LEs), which greatly limited the exploration on chlorides as cathode. Previously only a limited number of studies reported on chloride cathodes, most of which operate via a conversion mechanism and suffer from dissolution problems. Very recently VCl₃ was reported to have an intercalation-deintercalation reaction of Li when used in saturated thick electrolyte.

The new trend of replacing liquid electrolyte with solid electrolyte aims to enable Li-metal anode and boost the energy density. The emerging of solid electrolytes (SEs) eliminated the dissolution problem of chlorides and perhaps other compounds with similar problems. Particularly, recent reports on high performance halide SEs imply that halide SEs with good ionic conductivity and compatibility with high voltage cathode materials may provide an excellent testing bed for new groups of cathodes. Therefore, there is a need for highly reversible Li insertion/extraction in cathodes, in combination with halide SEs, while reducing the market price of the LIB as a whole.

### BRIEF SUMMARY

The present disclosure relates to alkali metal-ion batteries having cathode materials comprising a metal halide crystal lattice and methods for making the same. An exemplary embodiment of the present disclosure provides a metal halide having a formula of (Fe_{1-z}Ma)(Cl_{y}X_{3-y}), where M is a metal, X is a halogen, a is between 0 and 2.9, z is between 1 and 0, and y is between 0 and 3.

In any of the embodiments disclosed herein, M can be a metal selected from the group consisting of titanium, chromium, manganese, cobalt, nickel, copper, zinc, molybdenum, technetium, ruthenium, vanadium, tungsten, rhenium, osmium, lithium, sodium, potassium, rubidium, or cesium.

In some embodiments, X can be a halogen selected from fluorine, bromine, or iodine.

In some embodiments, the metal halide can include FeF₃, FeCl₃, FeBr₃, Fel₃, CrCl₃, CrBr₃, MnCl₃, or CrI₃.

In some embodiments, the metal halide can include an energy density of approximately 600 Wh/kg.

In some embodiments, the metal halide can be configured to be reversibly lithiated and delithiated upon exposure to lithium ions.

In some embodiments, the metal halide can be configured to be reversibly sodiated and desodiated upon exposure to sodium ions.

An exemplary embodiment of the present disclosure provides a solid-state battery including a cathode comprising a metal halide having a formula of (Fe_{1-z}Mₐ)(Cl_{y}X_{3-y}), where M is a metal, X is a halogen, a is between 0 and 2.9, z is between 1 and 0, and y is between 0 and 3. The battery can be configured to achieve an operating voltage greater than about 3 V versus a Li⁺/Li redox couple.

In some embodiments, the battery can be configured to achieve an operating voltage greater than about 3.3 V versus a Li⁺/Li redox couple.

In some embodiments, the battery can be configured to achieve an operating voltage greater than about 3.6 V versus a Li⁺/Li redox couple.

In some embodiments, the battery is further configured to achieve the operating voltage of approximately 3.6 V under a charge and discharge cycling capacity rate of approximately 0.1 C at 25° C.

In some embodiments, the battery is further configured to achieve the operating voltage of approximately 3.6 V under a charge and discharge cycling capacity of approximately 0.1 C at 60° C.

In some embodiments, the battery can be configured to achieve a reversible specific capacity greater than 150 mAh g⁻¹ versus a Fe²⁺/Fe³⁺ redox couple.

In some embodiments, the battery can be configured to achieve a cathode energy density equal to or greater than approximately 541 Wh kg⁻¹ based on a total weight of metal halide.

In some embodiments, the battery can be configured to achieve a cathode energy density of approximately 594 Wh kg⁻¹ based on a total weight of metal halide.

An exemplary embodiment of the present disclosure provides a solid-state battery including a solid electrolyte and a metal halide cathode comprising a formula: (Fe_{1-z}Mₐ)(Cl_{y}X_{3-y}), where M can be a metal, X can be a halogen, a can be between 0 and 2.9, z can be between 1 and 0, and y can be between 0 and 3.

In some embodiments, the battery can be configured to achieve an operating voltage greater than about 3 V versus a Li⁺/Li redox couple.

In some embodiments, the battery can be configured to achieve an operating voltage greater than about 3.3 V versus a Li⁺/Li redox couple.

In some embodiments, the battery can be configured to achieve an operating voltage equal to or greater than about 3.6 V versus a Li⁺/Li redox couple.

In some embodiments, the battery can be configured to achieve the operating voltage of approximately 3.6 V under a charge and discharge cycling capacity rate of approximately 0.1 at 25° C.

In some embodiments, the battery can be configured to achieve the operating voltage of approximately 3.6 V under a charge and discharge cycling capacity of approximately 0.1 at 60° C.

In some embodiments, the battery can be configured to achieve a reversible specific capacity greater than 150 mAh g⁻¹ versus a Fe²⁺/Fe³⁺ redox couple.

In some embodiments, the battery can be configured to achieve a cathode energy density greater than approximately 540 Wh kg⁻¹ based on a total weight of metal halide.

In some embodiments, the battery can be configured to achieve a cathode energy density of approximately 594 Wh kg⁻¹ based on a total weight of metal halide.

In some embodiments, the metal halide can include a cathode energy density of approximately 600 Wh kg⁻¹ based on a total weight of metal halide.

In some embodiments, the metal halide can include a metal selected from the group consisting of titanium, chromium, manganese, cobalt, nickel, copper, zinc, molybdenum, technetium, ruthenium, vanadium, tungsten, rhenium, osmium, lithium, sodium, potassium, rubidium, and cesium.

In some embodiments, the metal halide can include a halogen selected from fluorine, bromine, and iodine.

In some embodiments, the metal halide can include FeF₃, FeCl₃, FeBr₃, Fel₃, CrCl₃, CrBr₃, MnCl₃, or CrI₃.

In some embodiments, the solid electrolyte can include a compound including a formula: Aₐ(M_{E1})_{b}(M_{E2})_{c}(X_{E})_{d}, wherein: A can be one or more cations selected from the group consisting of lithium, sodium, potassium, rubidium, cesium, francium, beryllium, magnesium, calcium, strontium, barium, radium, silver, gold, titanium, or combinations thereof; M_{E1} can be one or more cations selected from the group consisting of iron, titanium, chromium, manganese, cobalt, nickel, copper, zinc, molybdenum, technetium, ruthenium, vanadium, tungsten, niobium, tantalum, lanthanum, boron, aluminum, scandium, gallium, yttrium, zirconium, indium, silicon, germanium, tin, arsenic, antimony, tellurium, thallium, lead, bismuth, polonium, or combinations thereof; M_{E2} can be one or more cations selected from the group consisting of boron, aluminum, scandium, gallium, yttrium, zirconium, indium, silicon, germanium, tin, arsenic, antimony, tellurium, thallium, lead, bismuth, polonium, or combinations thereof; M_{E1} and M_{E2} can comprise different cations; X_{E} can be one or more anions selected from the group consisting of fluorine, chlorine, bromine, iodine, or oxygen; a can be from 1 to 10; b and c are each independently less than 6; and d can be from 0 to 18.

In some embodiments, the solid electrolyte can include a compound including a formula: Aₐ(M_{E1}S₄)_{b}(PS₄)_{4-b}(X_{E})₃, wherein: A can be one or more cations selected from the group consisting of lithium, sodium, potassium, rubidium, cesium, francium, beryllium, magnesium, calcium, strontium, barium, radium, silver, gold, titanium, or combinations thereof; M_{E1} can be one or more cations selected from the group consisting of boron, aluminum, scandium, gallium, yttrium, zirconium, indium, silicon, germanium, tin, arsenic, antimony, tellurium, thallium, lead, bismuth, polonium, or combinations thereof; X_{E} can be selected from the group consisting of fluorine, chlorine, bromine, or iodine; a can be from 1 to 27; and b can be less than 4.

An exemplary embodiment of the present disclosure provides a method of making a solid-state battery. The method can include combining a cathode material with at least one solid electrolyte and anode and compressing the solid mixture in a water-free container at a pressure ranging from about 200 MPa to about 400 MPa to obtain the solid-state battery. The cathode material can include at least one compound selected from FeF₃, FeCl₃, FeBr₃, FeI₃, CrCl₃, CrBr₃, MnCl₃, or CrI₃.

In some embodiments, the solid electrolyte can include at least one compound selected from Li₃YCl₆, Li₂ZrCl₆, Li₃ScCl₆, Li₃YbCl₆, Li₃FeCl₆, Li_{2.75}In_{0.75}Zr_{0.25}Cl₆, Li₁₅P₄S₁₆Cl₃, Li_{15.5}Ge_{0.5}P_{3.5}S₁₅Cl₃, Li₁₆(SiS₄)(PS₄)₃Cl₃, Na₁₆(GeS₄)(PS₄)₃Br₃, Li₁₉(GaS₄)₂(PS₄)₂Cl₃, Li₁₆(GeS₄)(PS₄)₃Cl₃, Li_{2-x+2y}ZrCl₆₋ₓO_{y}, where x can be between 0 and 2 and y can be between 0 and 1, or combinations thereof.

In some embodiments, the method can further include charging and discharging the solid-state battery under the presence of lithium ions.

In some embodiments, the method can further include charging and discharging the solid-state battery under the presence of sodium ions.

In some embodiments, the method can further include achieving an operating voltage greater than about 3 V versus a Li⁺/Li redox couple.

In some embodiments, the method can further include achieving an operating voltage greater than about 3.3 V versus a Li⁺/Li redox couple.

In some embodiments, the method can further include achieving an operating voltage equal to or greater than about 3.6 V versus a Li⁺/Li redox couple.

In some embodiments, the method can further include achieving the operating voltage of approximately 3.6 V under a charge and discharge cycling capacity rate of approximately 0.1 at 25° C.

In some embodiments, the method can further include achieving the operating voltage of approximately 3.6 V under a charge and discharge cycling capacity of approximately 0.1 at 60° C.

In some embodiments, the method can further include achieving a reversible specific capacity greater than 150 mAh g⁻¹ versus a Fe²⁺/Fe³⁺ redox couple.

In some embodiments, the method can further include achieving a cathode energy density greater than approximately 540 Wh kg⁻¹ based on a total weight of metal halide.

In some embodiments, the method can further include achieving a cathode energy density of approximately 594 Wh kg⁻¹ based on a total weight of metal halide.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings.

While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic drawing of an example alkali metal-ion battery comprising a metal halide cathode material, in accordance with an exemplary embodiment of the present invention.

FIG. 2A provides a synchrotron X-ray diffraction (XRD) pattern of an example delithiated metal halide cathode material FeCl₃, in accordance with an exemplary embodiment of the present invention.

FIG. 2B provides an X-ray crystallography structure of the metal halide cathode material of FIG. 2A, in accordance with an exemplary embodiment of the present invention.

FIG. 3A provides a synchrotron X-ray diffraction (XRD) pattern of an example lithiated metal halide cathode material Li_{0.8}FeCl₃, in accordance with an exemplary embodiment of the present invention.

FIG. 3B provides an X-ray crystallography structure of the metal halide cathode material of FIG. 3A, in accordance with an exemplary embodiment of the present invention.

FIGS. 4A and 4B provide reversible lithium ion insertion and extraction in an example cathode comprising a metal halide crystal lattice, in accordance with an exemplary embodiment of the present invention. FIG. 4A shows a charge-discharge profile of FeCl₃ at 0.1 C at RT. FIG. 4B shows a CV curve of FeCl₃ at RT with a scan rate of 0.01 mV/s.

FIGS. 5A and 5B provide X-ray absorption near edge structure (XANES) spectra of example cathodes comprising metal halide crystal lattices of varying charge and discharge states, in accordance with an exemplary embodiment of the present invention.

FIG. 6 provides a schematic demonstration of operando Energy-dispersive X-ray diffraction (EDXRD) set-up, in accordance with an exemplary embodiment of the present invention.

FIG. 7 provides a schematic depiction of an example cathode comprising a metal halide crystal lattice and an Energy-dispersive X-ray diffraction (EDXRD) contour map between approximately 1.5 and 4.5 Angstroms (Å) of the cell before cycling, in accordance with an exemplary embodiment of the present invention.

FIG. 8 provides an EDXRD contour map zoomed into layer 5 (at an example cathode comprising a metal halide crystal lattice) between 2 and 3.5 Å of phase evolution during the initial discharging/charging process and corresponding galvanostatic discharging/charging voltage profile, in accordance with an exemplary embodiment of the present invention.

FIG. 9 provides an energy dispersive diffraction data between 2 and 3.5 Å in of phase evolution during the initial discharging/charging process and corresponding galvanostatic discharging/charging voltage profile, in accordance with an exemplary embodiment of the present invention.

FIGS. 10A and 10B provide electrochemical performance of an example cathode comprising a metal halide crystal lattice, in accordance with an exemplary embodiment of the present invention. FIG. 10A is cycling performance of an example cathode comprising a metal halide crystal lattice using LYC electrolyte at 0.1 charging rate (C) at room temperature, FIG. 10B is rate performance of an example cathode comprising a metal halide crystal lattice using LIZC/LYBC electrolytes at various charging rates (0.1 C, 0.3 C, 1 C, 2 C, 3 C, and 5 C) at 60° C.

FIG. 11A provides a cycling performance of an example cathode comprising a metal halide crystal lattice using LIZC/LYBC electrolytes 0.5 charging rate at 60° C., in accordance with an exemplary embodiment of the present invention.

FIG. 11B provides a comparison of specific capacity for an example cathode comprising a metal halide crystal lattice (indicated by a star) compared to lithium metal oxide cathodes and nickel manganese cobalt oxide cathodes, in accordance with an exemplary embodiment of the present invention.

FIG. 12A provides a synchrotron X-ray diffraction (XRD) pattern of ball-milled electrolyte material Li₃YCl₆ used with example cathode materials comprising a metal halide crystal lattice, in accordance with an exemplary embodiment of the present invention.

FIG. 12B provides an Arrhenius plot of ball-milled electrolyte material Li₃YCl₆ used with example cathode materials comprising a metal halide crystal lattice, in accordance with an exemplary embodiment of the present invention.

FIG. 13A provides a Rietveld refinement of fitted and observed XRD patterns of electrolyte material Li_{2.75}In_{0.75}Zr_{0.25}Cl₆ used with example cathode materials comprising a metal halide crystal lattice, in accordance with an exemplary embodiment of the present invention.

FIG. 13B provides an Arrhenius plot of ball-milled electrolyte material Li_{2.75}In_{0.75}Zr_{0.25}Cl₆ used with example cathode materials comprising a metal halide crystal lattice, in accordance with an exemplary embodiment of the present invention.

FIGS. 14A and 14B provide a comparison of energy density and cost of different cathode materials, in accordance with an exemplary embodiment of the present invention.

FIG. 15 provides a flowchart of a method of making a solid-state battery comprising an example cathode materials comprising a metal halide crystal lattice, in accordance with the disclosed technology

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

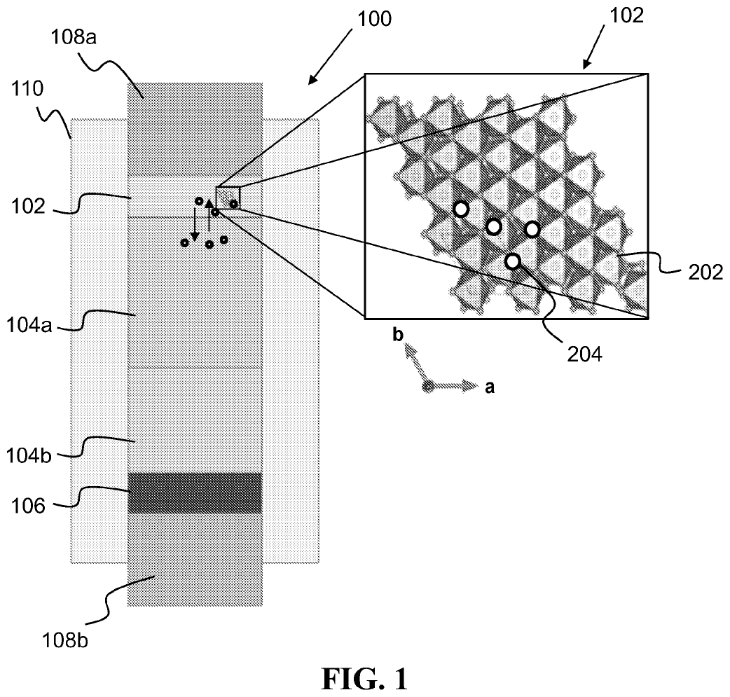

As described above, a problem with current electrochemical cells is the use of rare metals in the cathode and expenses related to market price for such materials. Mainly, it is desirable to have high specific capacity performance and ultra-low market price electrochemical cells to power transportation vehicles and consumer electronics. Additionally, many organic electrolytes used in current electrochemical cells are flammable, unsafe under harsh conditions, and cannot be used in combination with certain cathode materials. Elimination of the need for rare cathode materials and liquid electrolyte and a smaller, more lightweight size battery would greatly expand the design space of many industries, such as automotive, electric vehicles, solar power, renewable energy, IoT devices, smart homes, smart devices, solar cells, green packaging, magnetic devices, sensors, microelectronics, solid-state lighting, consumer electronics, in vivo electronics, aviation, aeronautics, power production, and the like. Compared to commercial electrochemical cells, solid-state electrochemical cells with non-flammable solid electrolytes (SEs) not only have much better safety properties, but also potentially provide higher energy density, if a lithium-metal anode can be enabled. Such an embodiment would provide for safer, lighter, and smaller batteries, an example of which can be seen in FIG. 1.

The present disclosure includes a cathode material, which is a very common industrial product, that presents excellent performance and ultra-low market price, (e.g., approximately 4% of the price compared to LiFePO₄ and 1% of the price compared of LiCoO₂). The cathode material dissolves in organic electrolytes. Therefore, the cathode material has not yet been studied for uses in high-density batteries. In the present disclosure, the cathode material is coupled with a solid electrolyte. In such a configuration, the cathode material can result in a flat voltage plateau averaged at 3.6 V, a high initial capacity of 152 mAh/g and very stable long cycling, as described in more detail herein. Neutron diffraction and XANES reveal that an example alkali metal-ion battery has a Li intercalation-deintercalation reaction during cycling and the active redox couple is M²⁺/M³⁺, where M is a metal as described below.

As shown in FIG. 1, an exemplary embodiment of the present invention provides an alkali metal-ion battery 100 comprising a cathode 102, at least one solid electrolyte 104a in contact with cathode 102, an anode 106, and at least one electrolyte 104b in contact with anode 106. Each of the cathode 102 and the anode 106 can also be in contact with a current collector 108a, 108b, such as a wire or other electrical conductor between the electrode and external circuits. Various current collectors can be used, such as, for instance, aluminum, copper, nickel, titanium, stainless steel, and the like. The alkali metal-ion battery 100 can be partially or completely enclosed is a housing 110, such as a PMMA sleeve, PVC heat shrink sleeve, plastic tube, or other insulating material.

Although FIG. 1 depicts a stacked cell unit, the alkali metal-ion battery 100 can be organized in any suitable orientation such that the cathode 102 is in contact at least one electrolyte 104b.

Cathode 102 can include a metal halide crystal lattice 202. The metal halide can include a composition having formula 1:

(Fe_{1-z}Mₐ)(Cl_{y}X_{3-y}). (1)

In some embodiments, M can be an element selected from the group consisting of post-transition metals and metalloids, such as titanium, chromium, manganese, cobalt, nickel, copper, zinc, molybdenum, technetium, ruthenium, vanadium, tungsten, rhenium, osmium, lithium, sodium, potassium, rubidium, or cesium, preferably lithium, manganese, cobalt, and nickel. X can be a halogen selected from fluorine, bromine, or iodine. In some embodiments, a can be a number between 0 and 2.9; z can be a number between 1 and 0; and y can be a number between 0 and 3. Example metal halides can include, without limitation, FeF₃, FeCl₃, FeBr₃, Fel₃, CrCl₃, CrBr₃, MnCl₃, CrI₃, FeMnCl₃.

Under battery conditions, the metal halide 202 can be configured to undergo lithiation as ions 204 of lithium flow from the solid electrolyte 104a to the cathode 102, as depicted in FIG. 1. Alternatively, or in addition thereto, the metal halide can reversibly accept and donate ions such as sodium or potassium, depending on the composition of the solid electrolyte.

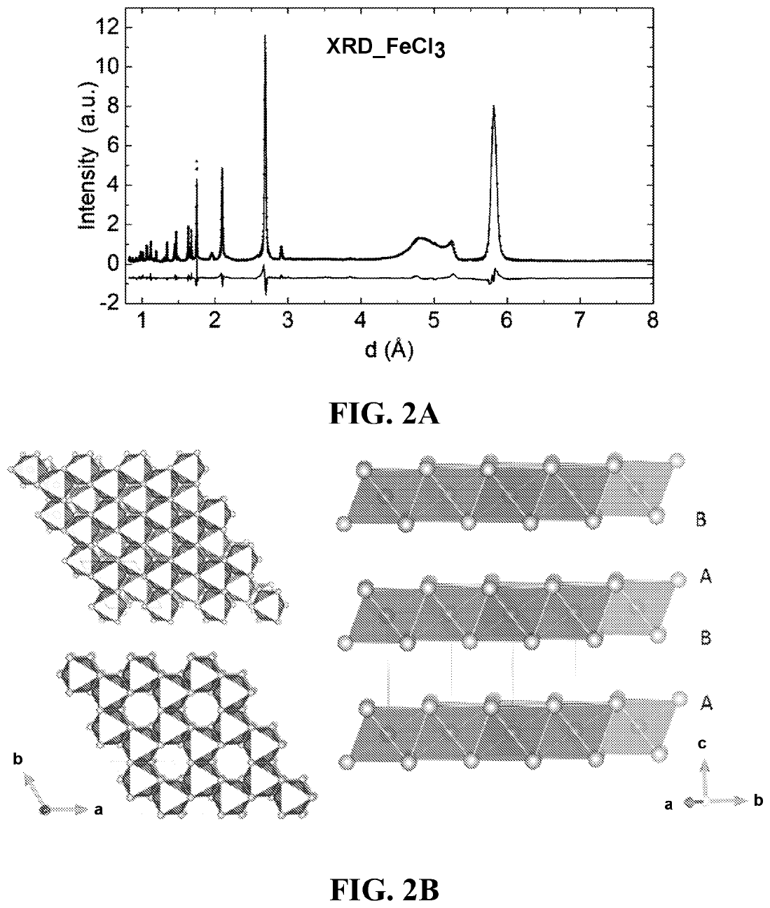

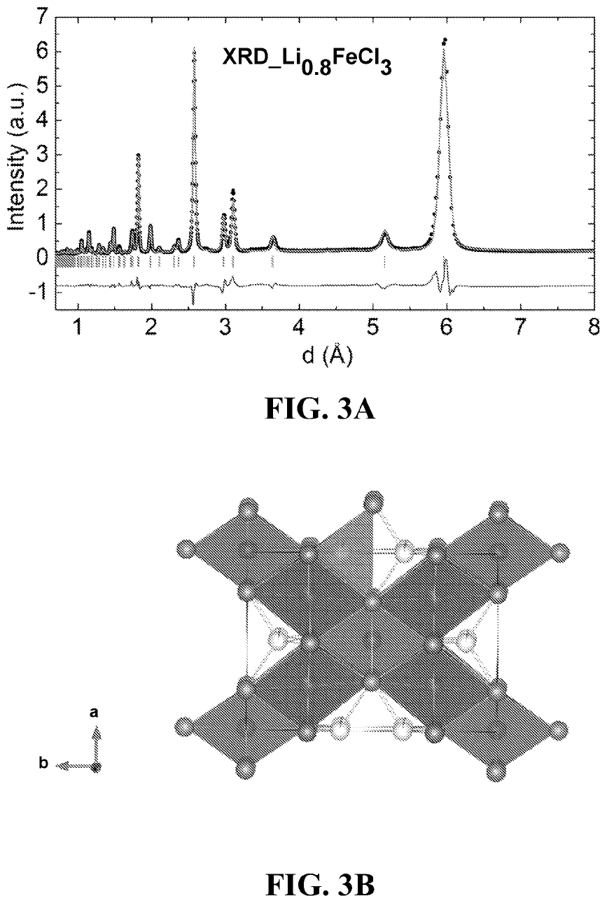

FIGS. 2A and 3A provide XRD patterns of the metal halide cathode before exposure to lithium ions (FIG. 2A) and after exposure to lithium ions (FIG. 3B). FIGS. 2B and 3B provides X-ray crystallography of a metal halide cathode before introduction of ions within the lattice (FIG. 2B) and after introduction of ions within the lattice (FIG. 3B).

In some embodiments, lithium, sodium, or potassium ions may migrate from the solid electrolyte into cathode material and form an ion-loaded metal halide cathode such as, for example, Li_{0.8}FeCl₃, Na_{0.2}FeCl₃, K_{2.4}FeCl₃. The amount of ion per unit cell can vary from approximately 0.1 to approximately 4 (e.g., Li_{0.1}FeCl₃, Li_{0.2}FeCl₃, Li_{0.3}FeCl₃, Li_{0.4}FeCl_{3,}Li_{0.5}FeCl₃, Li_{0.6}FeCl₃, Li_{0.7}FeCl₃, Li_{0.5}FeCl₃, Li_{0.9}FeCl₃, Li_{1.0}FeCl₃, Li_{1.1}FeCl₃, Li_{1.2}FeCl₃, Li_{1.3}FeCl₃, Li_{1.4}FeCl₃, Li_{1.5}FeCl₃, Li_{1.6}FeCl₃, Li_{1.7}FeCl₃, Li_{1.8}FeCl₃, Li_{1.9}FeCl₃, Li_{2.0}FeCl₃, Li_{3.0}FeCl₃, Li_{4.0}FeCl₃, and any value in between, for instance, Li_{1.12}FeCl₃ or Li_{3.63}FeCl₃).

In some embodiments, the first solid electrolyte 104a and the second solid electrolyte 104b can each independently include a compound of the formula Aₐ(M_{E1})_{b}(M_{E2})_{c}(X_{E})_{d}, where A, M_{E1}, and M_{E2} are one or more cations and X_{E} is one or more anions. In some embodiments, M_{E1} and M_{E2} can each independently be an element selected from the group consisting of post-transition metals and metalloids. Suitable examples of M_{E1} and M_{E2} can include, but are not limited to, iron, titanium, chromium, manganese, cobalt, nickel, copper, zinc, molybdenum, technetium, ruthenium, vanadium, tungsten, niobium, tantalum, lanthanum, boron, aluminum, scandium, gallium, yttrium, zirconium, indium, silicon, germanium, tin, arsenic, antimony, tellurium, thallium, lead, bismuth, polonium, or combinations thereof. For instance, M can comprise silicon such that the solid electrolyte presents a formula of Li_{15.5}Ge_{0.5}P_{3.5}S₁₅Cl₃. By way of another example wherein M is more than one cation, M can comprise gallium and germanium. Such an embodiment would create a mixture of two formulas, such as a mixture of Aₐ(GeS₄)_{b}(PS₄)_{4-b}(X_{E})₃ and Aₐ(GaS₄)_{b}(PS₄)_{4-b}(X_{E})₃. Some example solid electrolytes can include, for example, Li₃YCl₆, Li₂ZrCl₆, Li₃ScCl₆, Li₃YbCl₆, Li₃FeCl₆, Li_{2.75}In_{0.75}Zr_{0.25}Cl₆, Li₁₅P₄S₁₆Cl₃, Li_{15.5}Ge_{0.5}P_{3.5}S₁₅Cl₃, Li₁₆(SiS₄)(PS₄)₃Cl₃, Na₁₆(GeS₄)(PS₄)₃Br₃, Li₁₉(GaS₄)₂(PS₄)₂Cl₃, Li₁₆(GeS₄)(PS₄)₃Cl₃, Li_{2-x+2y}ZrCl₆₋ₓO_{y}, where x is between 0 and 2 and y is between 0 and 1.

In some embodiments, the first solid electrolyte 104a and the second solid electrolyte 104b can each independently present an ionic conductivity of 1.0×10⁻⁷ S/cm or greater (e.g., 1.5×10⁻⁷ S/cm or greater, 2.0×10⁻⁷ S/cm or greater, 3.0×10⁻⁷ S/cm or greater, 4.0×10⁻⁷ S/cm or greater, 5.0×10⁻⁷ S/cm or greater, 6.0×10⁻⁷ S/cm or greater, 7.0×10⁻⁷ S/cm or greater, 8.0×10⁻⁷ S/cm or greater, 9.0×10⁻⁷ S/cm or greater, 1.0×10⁻⁶ S/cm or greater, 2.0×10⁻⁶ S/cm or greater, 3.0×10⁻⁶ S/cm or greater, 4.0×10⁻⁶ S/cm or greater, 5.0×10⁻⁶ S/cm or greater, 6.0×10⁻⁶ S/cm or greater, 7.0×10⁻⁶ S/cm or greater, 8.0×10⁻⁶ S/cm or greater, 9.0×10⁻⁶ S/cm or greater, 1.0×10⁻⁵ S/cm or greater, 2.0×105 S/cm or greater, 3.0×10⁻⁵ S/cm or greater, 4.0×10⁻⁵ S/cm or greater, 5.0×105 S/cm or greater, 6.0×10⁻⁵ S/cm or greater, 7.0×10⁻⁵ S/cm or greater, 8.0×10⁻⁵ S/cm or greater, 9.0×10⁻⁵ S/cm or greater, 1.0×10⁻⁴ S/cm or greater, 2.0×10⁻⁴ S/cm or greater, 3.0×10⁻⁴ S/cm or greater, 4.0×10⁻⁴ S/cm or greater, 5.0×10⁻⁴ S/cm or greater, 6.0×10⁻⁴ S/cm or greater, 7.0×10⁻⁴ S/cm or greater, 8.0×10⁻⁴ S/cm or greater, 9.0×10⁻⁴ S/cm or greater, or 1.0×10⁻³ S/cm or greater) at room temperature.

In some embodiments, the first solid electrolyte 104a and the second solid electrolyte 104b can each independently present an ionic conductivity of 1.0×10⁻³ S/cm or less (e.g., 1.0×10⁻⁷ S/cm or less, 1.5×10⁻⁷ S/cm or less, 2.0×10⁻⁷ S/cm or less, 3.0×10⁻⁷ S/cm or less, 4.0×10⁻⁷ S/cm or less, 5.0×10⁻⁷ S/cm or less, 6.0×10⁻⁷ S/cm or less, 7.0×10⁻⁷ S/cm or less, 8.0×10⁻⁷ S/cm or less, 9.0×10⁻⁷ S/cm or less, 1.0×10⁻⁶ S/cm or less, 2.0×10⁻⁶ S/cm or less, 3.0×10⁻⁶ S/cm or less, 4.0×10⁻⁶ S/cm or less, 5.0×10⁻⁶ S/cm or less, 6.0×10⁻⁶ S/cm or less, 7.0×10⁻⁶ S/cm or less, 8.0×10⁻⁶ S/cm or less, 9.0×10⁻⁶ S/cm or less, 1.0×10⁻⁵ S/cm or less, 2.0×10⁻⁵ S/cm or less, 3.0×10⁻⁵ S/cm or less, 4.0×10⁻⁵ S/cm or less, 5.0×10⁻⁵ S/cm or less, 6.0×10⁻⁵ S/cm or less, 7.0×10⁻⁵ S/cm or less, 8.0×10⁻⁵ S/cm or less, 9.0×10⁻⁵ S/cm or less, 1.0×10⁻⁴ S/cm or less, 2.0×10⁻⁴ S/cm or less, 3.0×10⁻⁴ S/cm or less, 4.0×10⁻⁴ S/cm or less, 5.0×10⁻⁴ S/cm or less, 6.0×10⁻⁴ S/cm or less, 7.0×10⁻⁴ S/cm or less, 8.0×10⁻⁴ S/cm or less, or 9.0×10⁻⁴ S/cm or less) at room temperature.

Referring back to FIG. 1, when a battery includes cathode 102 comprising the metal halide material and a solid electrolyte of the present disclosure, the battery can achieve high-capacity performance that matches and surpasses the performance of typical lithium-ion batteries.

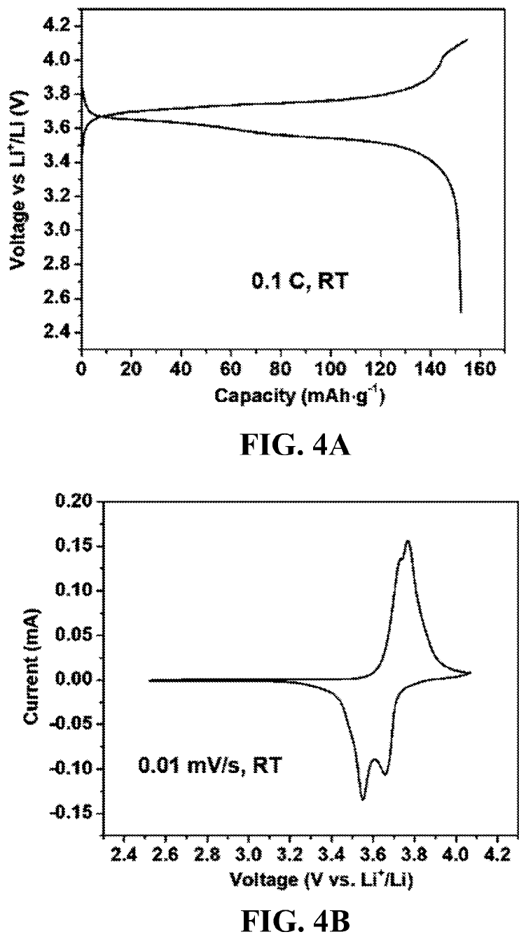

FIG. 4A shows the charge-discharge voltage profile of metal halide cathode FeCl₃ under a rate of 0.1 C at room temperature (plotted in voltage vs Li/Li+ for better comparison with other cathodes). A reversible specific capacity over 150 mAh g⁻¹ is observed, which is 91% of the theoretical capacity (165 mAh g⁻¹, calculated based on Fe²⁺/Fe³⁺ redox couple).

Two obvious very flat plateaus around 3.6 V are observed, implying possibly two two-phase intercalation processes. This voltage is much higher than that of lithium iron oxides (˜2 to 3V) and even higher than LifePO₄ (3.42 V) and FeF₃. Although not wishing to be tied by theory, the high voltage of the intercalation may be due to the combination of the high electronegativity chlorine atoms and the crystal structure.

Cyclic voltammetry (CV) curve in FIG. 4B also shows two cathodic and two anodic peaks (3.65/3.55 V vs. Li⁺/Li for cathodic peaks and 3.73/3.77 V vs. Li⁺/Li for anodic peaks), which are consistent with the two plateaus in the voltage profile. With such high voltage and capacity, the theoretical cathode energy density of the metal halide material, in one example of FeCl₃, approaches ˜600 Wh/kg and exceeding that of LifePO₄.

In general, the specific capacity and energy density are calculated based on the mass of active materials. In terms of the solid-state battery, the mass of electrolyte and anode are included; however, in reviewing the specific capacity and energy density attributable solely by the cathode, the energy density is equal to voltage multiplied by weight of just the metal halide cathode. In some embodiments, the average voltage of FeCl₃ is 3.65 V versus Li⁺/Li and the specific capacity (capacity/weight) of FeCl₃ is 165 mAh/g. Substituting the values into the formula, the energy density of FeCl₃ is calculated to be 602 Wh/kg based on the weight of FeCl₃.

As would be appreciated by skill in the relevant art, adjustment of the metal halide material and solid electrolyte can further increase the cathode energy density. In some embodiments, the battery can achieve a cathode energy density of approximately 600 Wh/kg (e.g., of approximately 599 Wh/kg, approximately 598 Wh/kg, approximately 597 Wh/kg, approximately 596 Wh/kg, approximately 595 Wh/kg, approximately 594 Wh/kg, approximately 593 Wh/kg, approximately 592 Wh/kg, approximately 591 Wh/kg, approximately 590 Wh/kg, approximately 585 Wh/kg, approximately 580 Wh/kg, approximately 575 Wh/kg, approximately 570 Wh/kg, approximately 565 Wh/kg, approximately 560 Wh/kg, approximately 555 Wh/kg, approximately 550 Wh/kg, approximately 545 Wh/kg, approximately 540 Wh/kg, approximately 535 Wh/kg, approximately 530 Wh/kg, approximately 525 Wh/kg, approximately 520 Wh/kg, approximately 515 Wh/kg, approximately 510 Wh/kg, approximately 505 Wh/kg, approximately 500 Wh/kg, approximately 490 Wh/kg, approximately 480 Wh/kg, and any value in between, e.g., approximately 523.82 Wh/kg or approximately 599.99 Wh/kg).

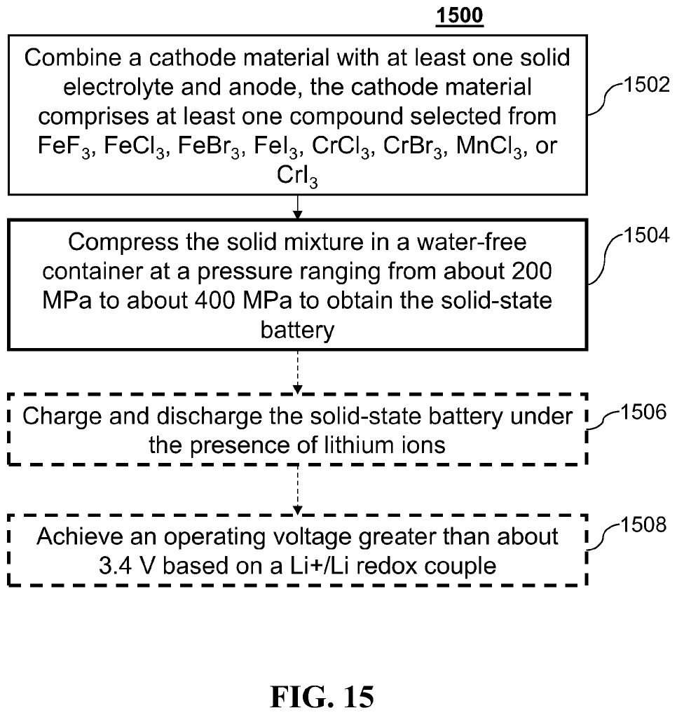

FIG. 15 is a flowchart of a method 1500 of manufacturing a solid-state battery, in accordance with the disclosed technology. The method 1500 can include combining a cathode material with at least one solid electrolyte and anode at step 1502. Wherein the cathode material comprises at least one compound selected from FeF₃, FeCl₃, FeBr₃, Fel₃, CrCl₃, CrBr₃, MnCl₃, or CrI₃. Method 1500 can include compressing the solid mixture in a water-free container at a pressure ranging from about 200 MPa to about 400 MPa to obtain the solid-state battery at step 1504. Compressing the solid mixture can also be conducted in a container filled with dry air. Method 1500 can optionally include charging and discharging the solid-state battery under the presence of lithium ions, sodium ions, or potassium ions, shown in step 1506. Method 1500 can optionally include achieving an operating voltage greater than about 3.4 V based on a Li+/Li redox couple, shown in step 1508. As will be appreciated, the method 1500 can include any of the previous examples described herein.

The following examples further illustrate aspects of the present disclosure. However, they are in no way a limitation of the teachings or disclosure of the present disclosure as set forth herein.

### EXAMPLES

Reversible lithium insertion/extraction in FeCl₃ in ALSOLIBs

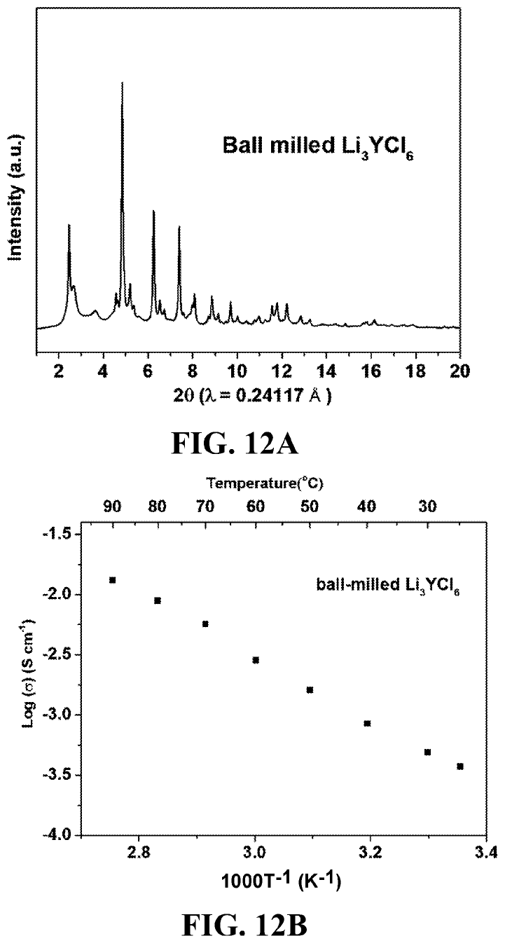

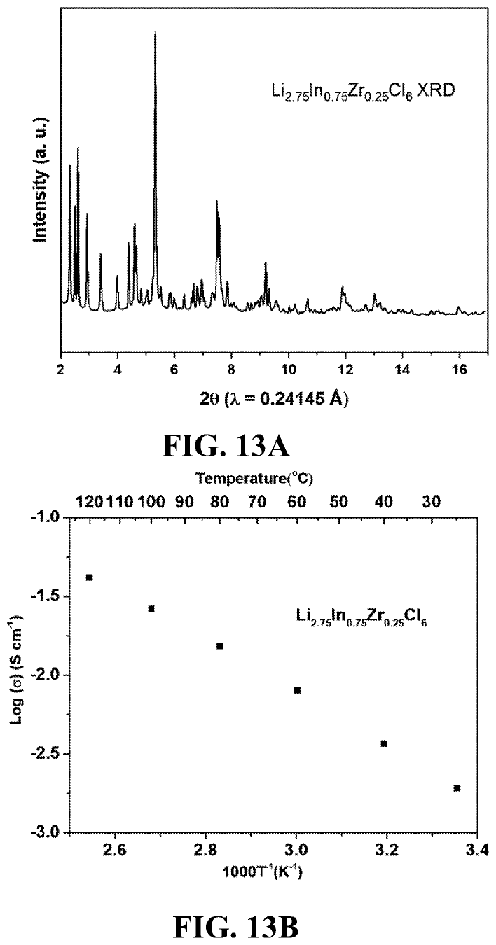

Anhydrous FeCl₃ were tested as-received from the commercial vendors, without any further processing. The particles are flakes with length of 1-2 μm and thickness of a few hundred nm (e.g., 100-200 nm, 200-300 nm, 300-400 nm, 400-500 nm, and the like). Ball-milled Li₃YCl₆ (LYC) was synthesized and used as the solid electrolyte to fabricate the ALSOLIB cell, owing to its high oxidation stability. The X-ray diffraction (XRD) pattern and electrochemical impedance spectroscopy (EIS) measurement of LYC are shown in FIG. 12A and of Li_{2.75}In_{0.75}Zr_{0.25}Cl₆ are shown in FIG. 13A. Cells with FeCl₃ composite cathode, LYC electrolyte and Li-In anode were cycled at room temperature.

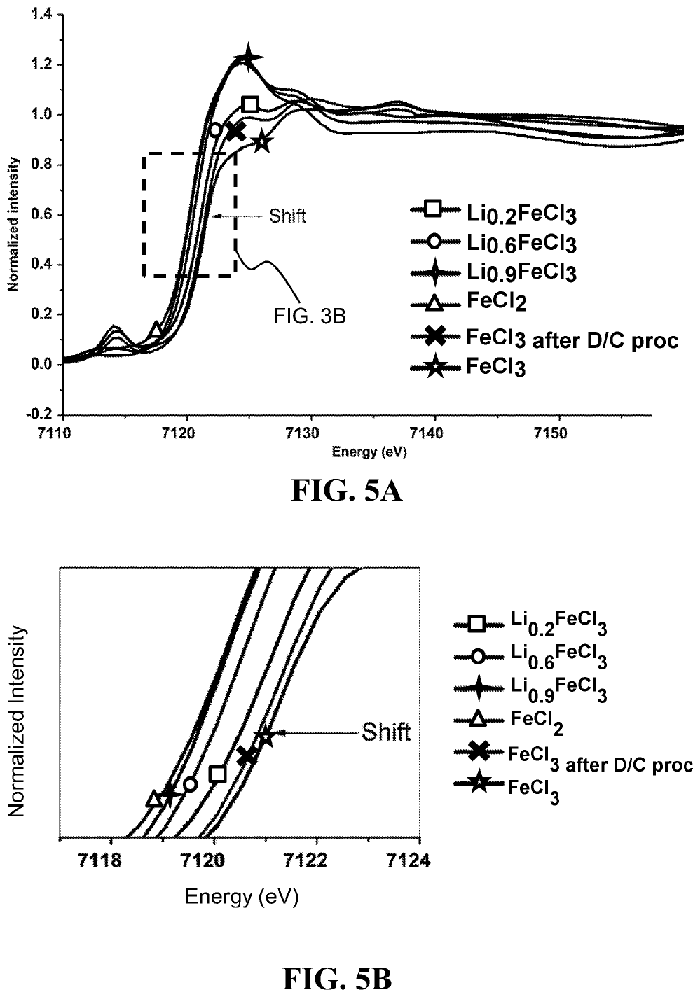

Ex situ X-ray absorption near edge structure (XANES) data was collected to characterize the change of oxidation state of Fe during charging-discharging process. FeCl₂ was used as the reference compound. As shown in FIGS. 5A and 5B, starting from pristine FeCl₃, with more Li inserted, the position of Fe K-edge shifts to lower energy, indicating the reduction of Fe³⁺ to Fe²⁺. When discharged to 1.9 V and 0.9 Li per formula unit of FeCl₃ inserted, the Fe K-edge position shifts to a position that almost superpose that of FeCl₂. When charged back to 3.5 V, the edge position shifts back to high energy, very close to that of pristine FeCl₃, indicating a highly reversible redox of the Fe³⁺/Fe²⁺ couple.

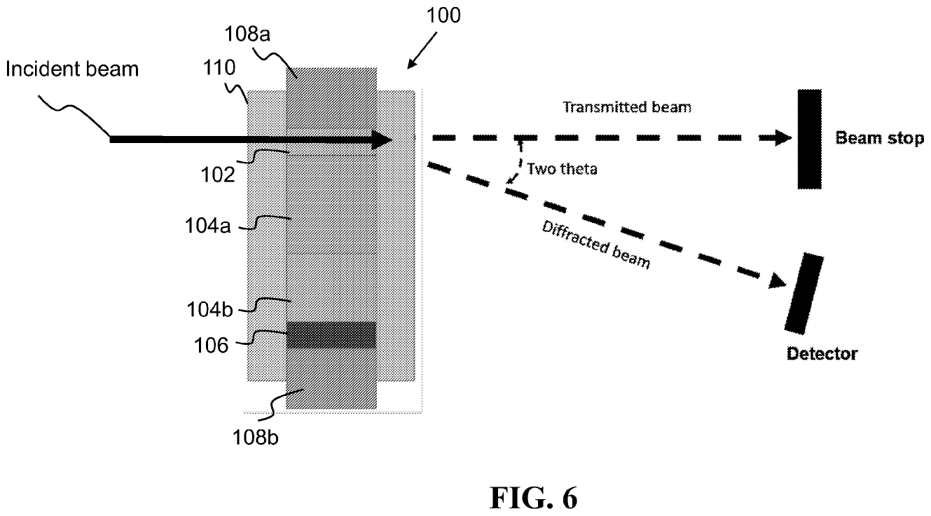

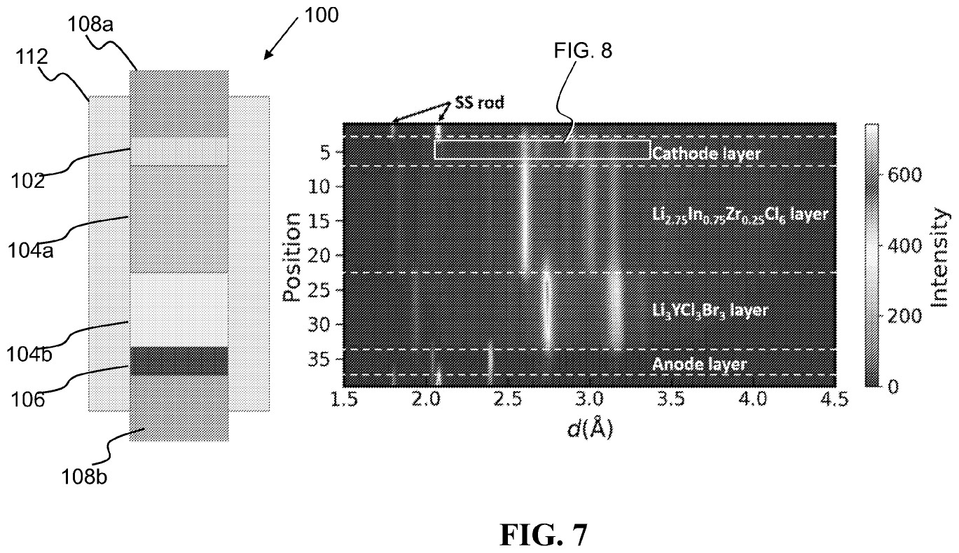

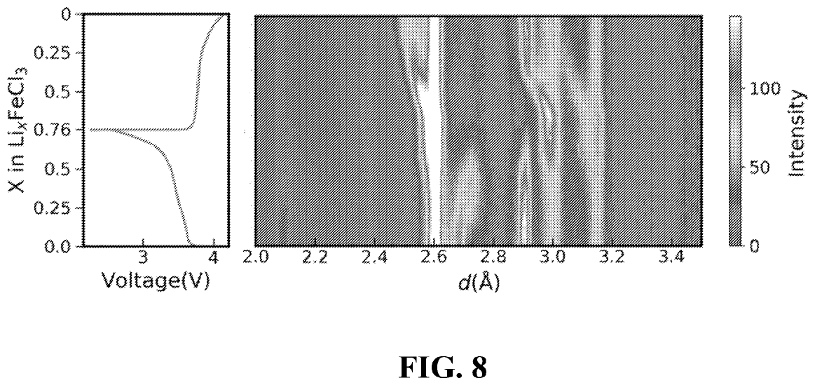

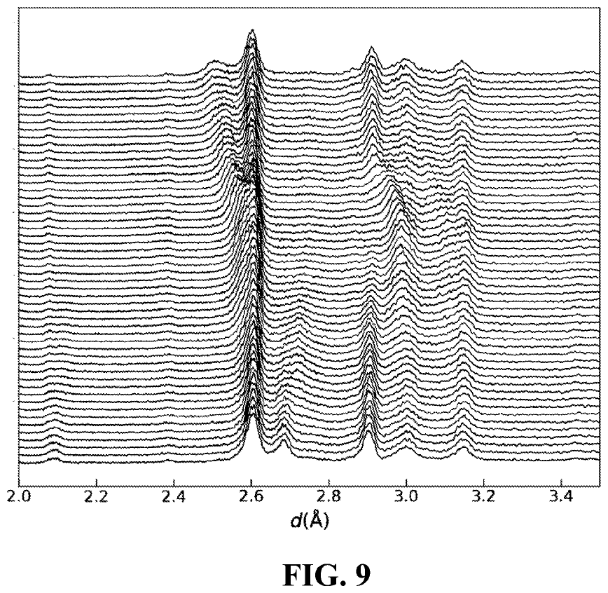

To illustrate Li storage mechanism in FeCl₃ during discharge/charge process, operando energy dispersive X-ray diffraction (EDXRD) measurements were performed, which provided structural information from controlled diffraction gauge volume of tens of microns. The schematic illustration of EDXRD setup is shown in extended data FIG. 6. Li_{2.75}In_{0.75}Zr_{0.25}Cl₆ (LIZC) with a room temperature ionic conductivity of 1.9 mS cm⁻¹ was used instead of LYC as the solid electrolyte. The crystal structure of LIZC was determined from Rietveld refinement against neutron diffraction (shown in FIG. 13A). The ionic conductivity and activation energy were determined by EIS test at varied temperature (shown in FIG. 13B). A thin layer of Li₃YCl₃Br₃ (LYCB) was used as protective layer between LIZC and anode layer. Scans were taken layer-by-layer along vertical direction, with an increment of 20 μm. FIG. 7 shows the contour plots of EDXRD measurements of the entire cell before cycling. The span between two stainless steel (SS) rod is ˜780 μm, with a cathode thickness of ˜100 μm. FIG. 8 shows contour maps between 2 and 3.5 Å in the cathode layer during the initial discharge/charge process. The corresponding diffraction patterns are plotted in FIG. 9. Reflections at 2.60, 3.02 and 3.15 Å are from electrolyte LIZC in cathode layer. FeCl₃ crystallizes in 3 structure and the strong reflections at 2.69 and 2.91 Å are from (113) and (006) lattice planes, respectively. They do not overlap with reflections from LIZC and thus are used to track the phase evolution of FeCl₃ during lithium insertion-extraction processes.

During the discharging process, two biphasic intercalation processes can be observed, which is similar to the lithiation process of VCl₃ in supersaturated electrolytes. With more Li insertion, reflections from pristine FeCl₃ become weaker and an intermediate phase (noted as phase α) appears with a reflection at 2.72 Å at a nominal composition of Li_{0.2}FeCl₃. The (113) reflection from FeCl₃ disappears at the nominal composition of Li_{0.35}FeCl₃, 3.47 V vs. Li⁺/Li, corresponding to the end of the first flat plateau during discharge. Phase α, shown in FIG. 2B, can be indexed to R3̅ structure with bigger lattice parameters than FeCl₃. Further Li insertion leads to the transformation of phase α to a more Li-rich phase (noted as phase β and shown in FIG. 3B) with reflections at positions close to LIZC at the end of discharge, implying they may share very similar anion framework.

During the charging process, phase β does not transform back to FeCl₃ following the reverse path of lithiation. Instead, a solid-solution delithiation regime between Li_{0.76}FeCl₃ and Li_{0.53}FeCl₃ is observed, with reflections at 2.60, 3.02 and 3.15 Å monotonic shifting to smaller d-spacing. Further extraction of Li ions leads to the formation of a new phase (noted as phase γ) with reflections at 2.53 and 2.91 Å. At the end of charging process, the EDXRD pattern of fully delithiated phase (noted as phase δ) is different from pristine FeCl₃, as there is no obvious reflection at 2.69 Å. Instead, a new reflection appears at lower d spacing position (2.50 Å).

To elucidate the crystal structure of an example metal halide material in the most lithiated form (phase β), synchrotron XRD and neutron powder diffraction (NPD) experiments were conducted. The diffraction patterns of phase β can be indexed to C2/m space group with chlorine atoms stacking in fcc form. The three space groups C2/m, C2 and Cm have the same systematic forbidden reflections which are caused by the C-centering (h+k=2n+1). The other symmetry operations in the three space groups, e.g. 2-fold rotation axis (2) and mirror plane (m) in the C2/m space group, do not cause forbidden reflections. Alternatively, or in addition thereto, metal halide cathode materials may also form various unit cells such as cubic (e.g., simple, body-centered, face-centered), tetragonal (e.g., simple, body-centered), mono-clinic (e.g., simple, end-centered), orthorhombic (e.g., simple, body centered, face-centered, end-centered), rhombohedral, hexagonal, or triclinic.

Difference Fourier maps generated from neutron diffraction patterns clearly show that Li ions reside in the octahedral/tetrahedral sites between FeCl₃ layers (FIG. 3B). FIG. 4d shows the synchrotron XRD pattern of phase 4, which can be indexed to C2/m space group. Compared with pristine FeCl₃, the fully delithiated FeCl₃ is a spinel-like structure and chlorine atoms keep fcc stacking form.

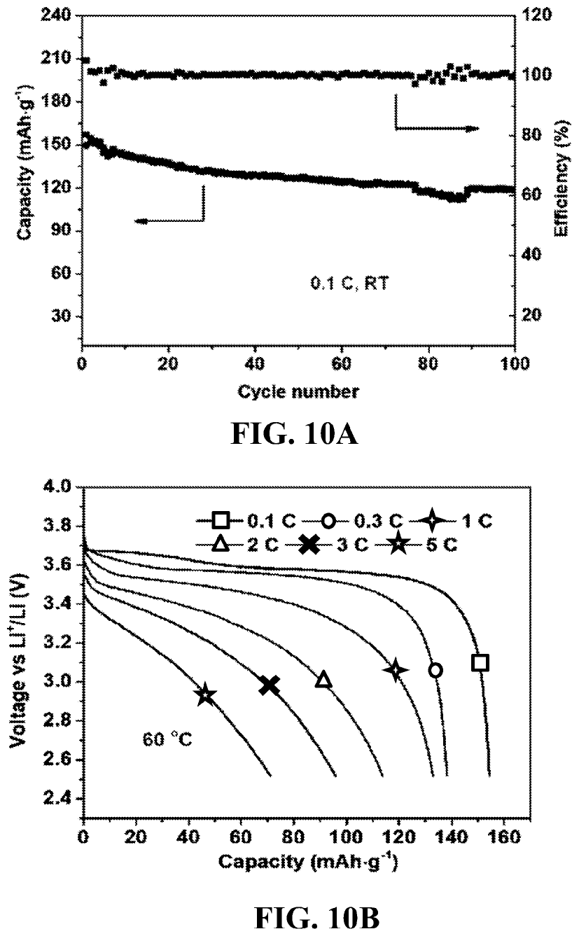

FIG. 10A shows the cycling performance of an example battery comprising a metal halide cathode material, FeCl₃, with LYC electrolyte at 0.1 C at RT. The cell displayed a specific capacity of 157 mAh g⁻¹ initially with a capacity retention of 78.8% after 100 cycles, demonstrating very good long term cycling stability. A battery comprising a metal halide cathode material may display a specific capacity equal to or greater than 130 mAh g⁻¹ (e.g., equal to or greater than about 135 mAh g⁻¹, equal to or greater than about 140 mAh g⁻¹, equal to or greater than about 145 mAh g⁻¹, equal to or greater than about 150 mAh g⁻¹, equal to or greater than about 155 mAh g⁻¹, equal to or greater than about 160 mAh g⁻¹, equal to or greater than about 165 mAh g⁻¹, equal to or greater than about 170 mAh g⁻¹, equal to or greater than about 175 mAh g⁻¹, equal to or greater than about 180 mAh g⁻¹, and any value in between, e.g., about 157 mAh g⁻¹ or about 172.4 mAh g⁻¹).

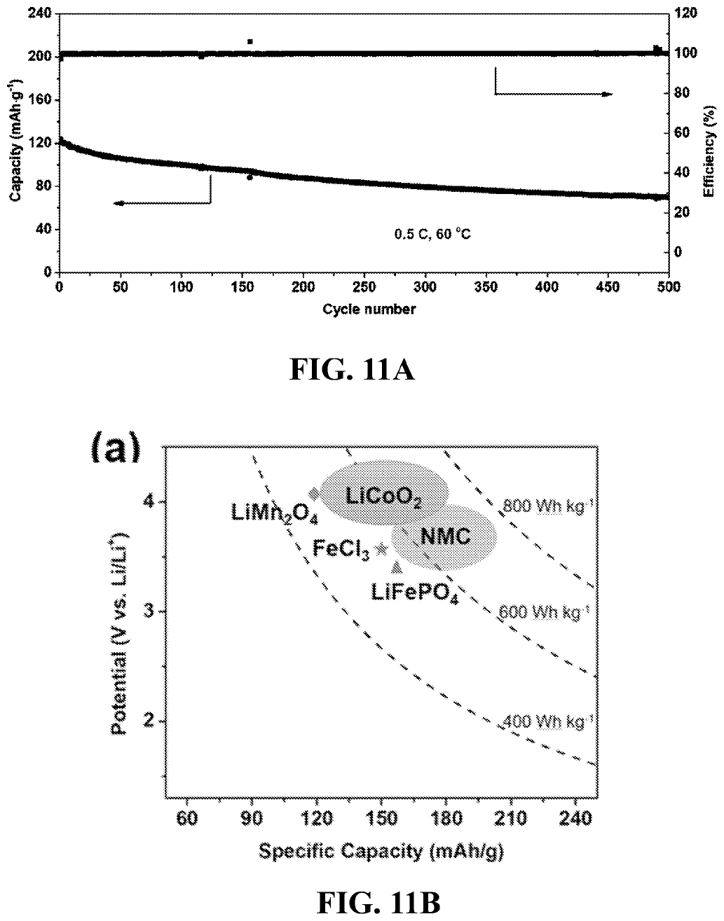

To test the rate capability of metal halide cathode, FeCl₃, Li_{2.75}In_{0.75}Zr_{0.25}Cl₆ (LIZC) with a r.t. ionic conductivity of 2 mS cm⁻¹ was used instead of LYC as the solid electrolyte. At 60° C., FeCl₃ cells exhibit very good rate performance, delivering a specific capacity of 135 mAh g⁻¹ at 1 C and a specific capacity over 70 mAh g⁻¹ at 5 C rate, as shown in FIG. 10B. FIG. 11A depicts a longer term cycling performance of FeCl3 test was performed at 0.5 C at 60° C. With an initial specific capacity of 121 mAh g⁻¹, a capacity of 70 mAh g⁻¹ is maintained after 500 cycles. In some embodiment, battery with metal halide cathode can maintain a capacity of 70 mAh g⁻¹ or greater for more than 500 cycles (e.g., about 550 cycles, about 600 cycles, about 650 cycles, about 700 cycles, about 750 cycles, about 800 cycles, about 850 cycles, about 900 cycles, about 950 cycles, about 1000 cycles, and any number of cycles in between, e.g., 523 cycles). In above electrochemical tests, FeCl₃ has shown excellent capacities and very good cycling stability.

FIG. 11B compares the energy density of FeCl₃ with several typical intercalation cathodes which are popularly used in commercial lithium ion batteries. FeCl₃ exhibits higher voltage (3.6 V vs. 3.4 V) than LiFePO₄ and similar theoretical capacity (165 mAh g⁻¹ vs. 170 mAh g⁻¹), and overall higher energy density (594 Wh kg⁻¹) than that of LiFePO₄ (540 Wh kg⁻¹) and LiMn₂O₄ (480 Wh kg⁻¹). Beyond the excellent electrochemical performances, the most appealing feature of FeCl₃ cathode is its low cost.

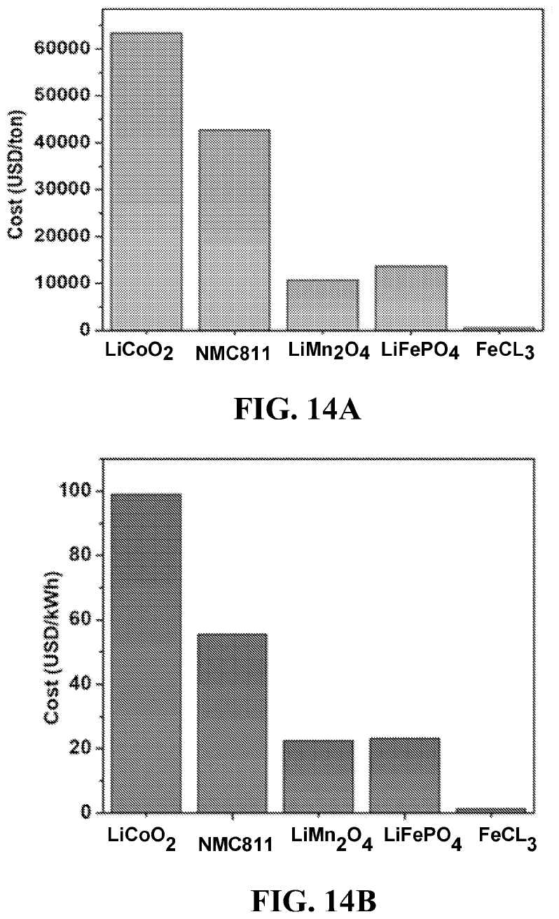

FIGS. 14A and 14B summarized the market prices in November 2021 of LiCoO₂, NMC811, LiMn₂O₄ and FeCl₃. The prices of lithium metal oxides cathodes ranging from 10787 (LiMn₂O₄) to 63386 (LiCoO₂) USD per ton. The price of LiFePO₄ is also above $10000/ton. In comparison, the market price of FeCl₃ is only 600 USD per ton, which potentially reduces the cost from cathode materials from $22.47˜99.04 kWh⁻¹ to $1.35 kWh⁻¹, if replacing layered oxides with FeCl₃ (FIG. 6c). And as a consequence, it is likely to reduce the cost of LIB cells from ˜$200 kWh⁻¹ to $50-100 kWh⁻¹ in future.

The reversible lithium insertion/extraction in FeCl₃ was realized via using solid state electrolyte and the phase evolution mechanism during charge/discharge process was clarified by using EDXRD, ex situ synchrotron and neutron diffraction technique. As a new type of cathode material, FeCl₃ exhibit satisfying energy density and cycling stability at both RT and elevated temperature (60° C.) in ALSOLIBs. The high energy density (540 Wh kg⁻¹) and much lower market price makes FeCl₃ a promising candidate, which potentially pave the road towards further development of ALSOLIBs.

### Materials Synthesis

For Li₃YCl₆ synthesis, a stoichiometric LiCI (Sigma-Aldrich) and YCl₃ (Sigma-Aldrich) were mechanically milled in a planary ball mill (PM 200. Retsch) with using zirconia jars (50 mL) at 500 rpm for 5 h under argon atmosphere.

Li_{2.75}In_{0.75}Zr_{0.25}Cl₆ were synthesized via high energy ball milling, followed by a post annealing treatment. LiCl (Sigma-Aldrich), InCl₃ () and ZrCl₄ () were weighted at the targeted ratio and ball milled at 500 rpm for 5 h. The ball-milled mixture were pelletized and placed in a sealed quartz tube. The pellet was heated at 425° C. for 5 h, then cooled to room temperature within the furnace.

Li₃YCl₃Br₃ were prepared following the same synthesis protocol. LiBr (Sigma-Aldrich) and YCl₃ (Sigma-Aldrich) were ball milled for 5 h followed by sintering. All the treatments were under Argon atmosphere.

### Ex Situ Synchrotron and Neutron Powder Diffraction.

Synchrotron X-ray diffraction patterns were collected at synchrotron X-ray source at beamline 17-BM (at the Advanced Photon Source (APS)). High-quality powder neutron powder diffraction (NPD) data were collected at r.t. at POWGEN and NOMAD at the Spallation Neutron Source (SNS) at Oak Ridge National Laboratory (ORNL) with a center wavelength 1.5 Å. Rietveld refinements against the XRD and ND data were performed with using GSAS II and TOPAS. For data analysis using neutron diffraction data, time-of-flight (TOF) data were converted to d-spacing data using the polynomial TOF=ZERO+DIFC*d+DIFA*d2+DIFB/d, where ZERO is a constant, DIFC is the diffractometer constant and DIFA and DIFB is empirical terms to correct the sample displacement and absorption caused peak shift. During the refinement, ZERO, DIFC and DIFB were determined from the refinement using a standard NIST Si 640d, while DIFA was allowed to vary to account for the sample displacements. A back to back exponential function convoluted with symmetrical Gaussian function were used to describe the peak profile.

### Electrochemical Measurements

The ionic conductivity was measured by EIS with using an electrochemical impedance analyzer (VMP3, Bio-logic) and a homemade electrochemical cell. Typically, 0.5˜1 g electrolyte powders were cold pressed into pellets with a diameter of ½ inch at a pressure of 294 MPa. Two pieces of Al foils were used as current collectors and the EIS data was collected at varied temperatures in the frequency range of 1 MHz to 1 Hz with an AC amplitude of 50 mV.

The cathode of all-solid-state cells consisted of FeCl₃ (purity 98%, Spectrum chemical), synthesized solid electrolytes (Li₃YCl₆ or Li_{2.75}In_{0.75}Zr_{0.25}Cl₆) and acetylene black (AB) powder. They were mixed in a 55:40:5 (wt %) ratio in a mortar by hand. In all-solid-state cells, InLi alloys were used as anode materials. After the InLi alloys with a nominal composition of InLi were prepared by pressing In and Li metal together at 294 MPa, they were then mixed with LYCB in a weight ratio of 70:30 in a mortar by hand. The solid electrolyte powders were used as the separator. To fabricate all-solid-state cell with using LYC electrolyte, 120 mg LYC powder was placed into a PMMA sleeve and pressed at 294 MPa, and then 10 mg FeCl₃/LYC/AB composite cathode mixture was pressed on one side of LYC pellet with a pressure of 294 MPa. 25 mg Composite anode mixture was pressed on the other side of LYC pellet. The procedure to fabricate all-solid-state cell with using LIZC electrolyte follows similar method, with 80 mg LYBC used as protective layer between LIZC and anode layer. The all-solid-state cell for operando EDXRD measurement utilizes LIZC electrolyte, with a composite cathode mass loading of 25 mg and composite anode mass loading of 50 mg. Cycling test were conducted at room temperature and 60° C. in galvanostatic mode between 1.9 to 3.5 V.

Cyclic voltammetry (CV) measurements were performed on the all-solid-state cell with LIZC electrolyte. The data was collected with using an electrochemical impedance analyzer (VMP3, Bio-logic) at a scan rate of 0.01 mV s⁻¹ from 1.9 to 3.5 V.

### Operando Energy Dispersive X-ray Diffraction.

Operando EDXRD measurements were conducted at the 6-BM-A beamline at Advanced Photon Source in Argonne National Lab. The incident beam size is 2.00 mm×0.020 mm and the receiving slit sizes are 4.00 mm×0.20 mm. A germanium detector was fixed at 2.301084° to measure the intensity of the diffracted beam. The vertical length of all-solid-state cell was scanned layer-by-layer with a step size of 20 μm. The data acquisition time was 30 s and a Savitzky-Golay filter was used to smooth the data.

### X-ray Absorption Near Edge Structure

The change of the oxidation state of Fe during discharging/charging was examined by synchrotron Fe K-edge X-ray absorption spectroscopy (XAS) conducted at Beamline 12-BM-B at the Advanced Photon Source (APS), Argonne National Laboratory (Lemont, IL, US). Sample solids were loaded to epoxy sealed Kapton capillary tubes in Ar atmosphere. XANES (X-ray absorption near edge structure) data were collected, and energy calibrated with Fe foil. Each sample collected multiple scans (4-6), averaged, and were normalized. Fe XANES data analysis was performed with Athena.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A battery comprising:
a cathode material comprising a metal halide having a formula:
(Fe_{1-z}Mₐ)(Cl_{y}X_{3-y});
wherein:
M is a metal;
X is a halogen;
a is between 0 and 2.9;
z is between 1 and 0; and
y is between 0 and 3.

2. (canceled)

3. The cathode battery of claim , wherein M is selected from the group consisting of titanium, chromium, manganese, cobalt, nickel, copper, zinc, molybdenum, technetium, ruthenium, vanadium, tungsten, rhenium, osmium, lithium, sodium, potassium, rubidium, and cesium.

4. The cathode battery of claim 1, wherein X is a halogen selected from the group consisting of fluorine, bromine, and iodine.

5. The cathode battery of claim 1, wherein the metal halide comprises is selected from the group consisting of FeF₃, FeCl₃, FeBr₃, Fel₃, CrCl₃, CrBr₃, MnCl₃, and CrI₃.

6. The cathode battery of claim 1, wherein the metal halide comprises an energy density of approximately 600 Wh/kg.

7. The cathode battery of claim 1, wherein the metal halide is configured to be reversibly lithiated and delithiated upon exposure to lithium ions.

8. The cathode battery of claim 1, wherein the metal halide is configured to be reversibly sodiated and desodiated upon exposure to sodium ions.

9. The battery of claim 1, wherein:
the battery is a solid-state battery; and
the battery is configured to achieve an operating voltage greater than about 3 V versus a Li+/Li redox couple.

10. The battery of claim 9, wherein the battery is configured to achieve an operating voltage greater than about 3.3 V versus a Li+/Li redox couple.

11. The battery of claim 9, wherein the battery is configured to achieve an operating voltage greater than about 3.6 V versus a Li+/Li redox couple.

12. The battery of claim 11, wherein the battery is further configured to achieve the operating voltage of approximately 3.6 V under a charge and discharge cycling capacity rate of approximately 0.1 C at 25° C.

13. The battery of claim 11, wherein the battery is further configured to achieve the operating voltage of approximately 3.6 V under a charge and discharge cycling capacity of approximately 0.1 C at 60° C.

14. The battery of claim 9, wherein the battery is further configured to achieve a reversible specific capacity greater than 150 mAh g⁻¹ versus a Fe²⁺/Fe³⁺ redox couple.

15. The battery of claim 9, wherein the battery is further configured to achieve a cathode energy density equal to or greater than approximately 541 Wh kg⁻¹ based on a total weight of metal halide.

16. (canceled)

17. A solid state The battery of claim 1 further comprising:
a solid electrolyte;
wherein the battery is a solid-state battery.

18.-19. (canceled)

20. The solid-state battery of claim 17, wherein the battery is configured to achieve an operating voltage equal to or greater than about 3.6 V versus a Li+/Li redox couple.

21. The solid-state battery of claim 20, wherein the battery is configured to achieve the operating voltage of approximately 3.6 V under a charge and discharge cycling capacity rate of approximately 0.1 at 25° C.

22. (canceled)

23. The solid-state battery of claim 17, wherein the battery is configured to achieve:
a reversible specific capacity greater than 150 mAh g⁻¹ versus a Fe²⁺/Fe³⁺ redox couple; and
a cathode energy density greater than approximately 540 Wh kg⁻¹ based on a total weight of metal halide.

24.-29. (canceled)

30. The solid-state battery of claim 17, wherein the solid electrolyte comprises a compound comprising having a formula:
Aₐ(M_{E1})_{b}(M_{E2})(X_{E});
wherein:
A is one or more cations selected from the group consisting of lithium, sodium, potassium, rubidium, cesium, francium, beryllium, magnesium, calcium, strontium, barium, radium, silver, gold, titanium, and combinations thereof;
M_{E1} is one or more cations selected from the group consisting of iron, titanium, chromium, manganese, cobalt, nickel, copper, zinc, molybdenum, technetium, ruthenium, vanadium, tungsten, niobium, tantalum, lanthanum, boron, aluminum, scandium, gallium, yttrium, zirconium, indium, silicon, germanium, tin, arsenic, antimony, tellurium, thallium, lead, bismuth, polonium, and combinations thereof;
M_{E2} is one or more cations selected from the group consisting of boron, aluminum, scandium, gallium, yttrium, zirconium, indium, silicon, germanium, tin, arsenic, antimony, tellurium, thallium, lead, bismuth, polonium, and combinations thereof,
M_{E1} and M_{E2} comprise different cations;
X_{E} is one or more anions selected from the group consisting of fluorine, chlorine, bromine, iodine, and oxygen;
a is from 1 to 10;
b and c are each independently less than 6; and
d is from 0 to 18.

31. The solid-state battery of claim 17, wherein the solid electrolyte comprises a compound comprising having a formula:
Aₐ(M_{E1}S₄)_{b}(PS₄)_{4-b}(X_{E})₃;
wherein:
A is one or more cations selected from the group consisting of lithium, sodium, potassium, rubidium, cesium, francium, beryllium, magnesium, calcium, strontium, barium, radium, silver, gold, titanium, and combinations thereof;
M_{E1} is one or more cations selected from the group consisting of boron, aluminum, scandium, gallium, yttrium, zirconium, indium, silicon, germanium, tin, arsenic, antimony, tellurium, thallium, lead, bismuth, polonium, and combinations thereof;
X_{E} is selected from the group consisting of fluorine, chlorine, bromine, and iodine;
a is from 1 to 27; and
b is less than 4.

32. A method of making a solid-state battery comprising a solid electrolyte and a cathode material comprising a metal halide having a formula (Fe_{1-z}Mₐ)(Cl_{y}X_{3-y}), wherein M is a metal, X is a halogen, a is between 0 and 2.9, z is between 1 and 0, and y is between 0 and 3, the method comprising:
forming a solid mixture of the cathode material, the solid electrolyte and an anode; and
compressing the solid mixture in a water-free container at a pressure ranging from about 200 MPa to about 400 MPa to obtain the solid-state battery.

33. The method of claim 32, wherein:
the solid electrolyte comprises at least one compound selected from the group consisting of Li₃YCl₆, Li₂ZrCl₆, Li₃ScCl₆, Li₃YbCl₆, Li₃FeCl₆, Li_{2.75}In_{0.75}Zr_{0.25}Cl₆, Li₁₅P₄S₁₆Cl₃, Li_{15.5}Ge_{0.5}P_{3.5}S₁₅Cl₃, Li₁₆(SiS₄)(PS₄)₃Cl₃, Na₁₆(GeS₄)(PS₄)₃Br₃, Li₁₉(GaS₄)₂(PS₄)₂Cl₃, Li₁₆(GeS₄)(PS₄)₃Cl₃, Li_{2-x+2y}ZrCl₆₋ₓO_{y}, and combinations thereof;
x is between 0 and 2; and
y is between 0 and 1.

34. The method of claim 32 further comprising at least one of:
charging and discharging the solid-state battery under the presence of lithium ions;
charging and discharging the solid-state battery under the presence of sodium ions;
achieving an operating voltage greater than about 3 V versus a Li⁺/Li redox couple;
achieving an operating voltage greater than about 3.3 V versus a Li⁺/Li redox couple;
achieving an operating voltage equal to or greater than about 3.6 V versus a Li⁺/Li redox couple;
achieving the operating voltage of approximately 3.6 V under a charge and discharge cycling capacity rate of approximately 0.1 at 25° C.;
achieving the operating voltage of approximately 3.6 V under a charge and discharge cycling capacity of approximately 0.1 at 60° C.;
achieving a reversible specific capacity greater than 150 mAh g⁻¹ versus a Fe²⁺/Fe³⁺ redox couple;
achieving a cathode energy density greater than approximately 540 Wh kg⁻¹ based on a total weight of metal halide; or achieving a cathode energy density of approximately 594 Wh kg⁻¹ based on a total weight of metal halide

35.-43. (canceled)
